(19) United States
(12) Patent Application Publication
(10) Pub. No.: US 2026/0238548 A1
(43) Pub. Date: Aug. 13, 2026

(54) METHOD AND DEVICE FOR SYNCHRONIZING UE POLICY BETWEEN NETWORK AND UE IN WIRELESS COMMUNICATION SYSTEM

(71) Applicant: SAMSUNG ELECTRONICS CO., LTD., Suwon-si, Gyeonggi-do (KR)

(72) Inventors: Dongyeon KIM, Suwon-si (KR); Jicheol LEE, Suwon-si (KR); Kyungjoo SUH, Suwon-si (KR)

(21) Appl. No.: 19/154,749

(22) PCT Filed: Feb. 6, 2024
(86) PCT No.: PCT/KR2024/001699

§ 371 Date: Aug. 7, 2025

(30) Foreign Application Priority Data
Feb. 9, 2023 (KR) 10-2023-0017273

(51) Int. Cl. H04L 41/0894; H04W 76/10

(52) U.S. Cl. CPC H04L 41/0894; H04W 76/10

(57) ABSTRACT

The present disclosure relates to a 5G or 6G communication system for supporting higher data transmission rates. A method performed by means of a policy control function (PCF) entity in a wireless communication system, according to the disclosure, may comprise the steps of: receiving, from an access and mobility management (AMF) entity, a first message including information for requesting establishment of a user equipment (UE) policy association; receiving, from a user data repository (UDR) entity, a second message including information related to a first UE policy; identifying, on the basis of the first message and the second message, whether re-synchronization of UE policy information is necessary; identifying the re-synchronization of the UE policy information if a UE policy container is not included in the information for requesting the establishment of the UE policy association; and identifying, on the basis of the identification of the re-synchronization, a second UE policy, which is different from the first UE policy.

### TECHNICAL FIELD

The disclosure relates to a wireless communication system or a mobile communication system. Specifically, the disclosure relates to a method and device for synchronizing a UE policy between a network and a UE in a wireless communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a procedure in which, in a wireless communication system or a mobile communication system, when a network determines that there is a possibility of mismatch between UE policy information stored in the network and UE policy information stored in a UE, the network request the UE to perform synchronization such that the UE policy information stored in the UE is consistent with the information determined by the network.

In addition, the disclosure provides a method and device for allowing a network to request a UE to synchronize UE policy information during a UE policy association establishment phase, including a change with respect to the PCF and AMF, in a wireless communication system.

### Solution to Problem

According to an embodiment of the disclosure, a method performed by a policy control function (PCF) entity in a wireless communication system may include receiving, from an access and mobility management function (AMF) entity, a first message including information requesting the establishment of a user equipment (UE) policy association, receiving, from a user data repository (UDR) entity, a second message including information related to a first UE policy, identifying, based on the first message and the second message, whether re-synchronization of UE policy information is required, determining re-synchronization of the UE policy information when the UE policy container is not included in the information requesting the establishment of the UE policy association, and based on the determination of the re-synchronize, determining a second UE policy different from the first UE policy.

### BRIEF DESCRIPTION OF DRAWINGS

FIG. 1 illustrates a network structure and interfaces of a wireless communication system according to an embodiment of the disclosure.

FIG. 2 illustrates a roaming architecture of a wireless communication system according to an embodiment of the disclosure.

FIG. 3 illustrates a roaming architecture of a wireless communication system according to an embodiment of the disclosure.

FIG. 4 illustrates a network structure and interfaces of a 5G system according to an embodiment of the disclosure.

FIG. 5 illustrates a UE policy synchronization procedure between a network and a UE according to an embodiment of the disclosure.

FIG. 6 illustrates a structure of a base station according to an embodiment of the disclosure.

FIG. 7 illustrates a structure of a UE according to an embodiment of the disclosure.

FIG. 8 illustrates a structure of a network entity according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help an understanding of the disclosure and the disclosure is not limited to configurations or arrangements illustrated in the drawings of the disclosure. In addition, a detailed description of known functions or configurations that may make the subject matter of the disclosure unclear will be omitted. It should be noted that in the following description of the disclosure, only parts necessary for understanding operations according to various embodiments of the disclosure will be described and descriptions of the other parts will be omitted so as not to make the subject matter of the disclosure obscure. Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

The recently commercialized 5G system (5GS), along with the currently deployed LTE and LTE-A systems, is a wireless communication system that provides packet-based services. 5GS is being developed to support interworking with the evolved packet system (EPS), which is based on LTE and LTE-A. In the 5G system, the 5G core (5GC) network may provide UE policy information to the UE.

Currently, in the 5G system, UE policy information determined by the PCF may be provided to the UE via the AMF, and the PCF may store, in UDR, the UE policy information provided to the UE. The PCF may perform a management function to ensure that the UE policy information stored in the UDR and provided to the UE remains up-to-date and consistent with the UE policy information actually stored in the UE.

Depending on various events that may occur in the network, the PCF may newly determine a UE policy for the UE, and depending on various events that may occur in the UE, the UE may lose the UE policy data provided by the network. As a result, there is a possibility that the UE policy information stored in the network and the UE policy information stored in the UE become inconsistent. This may cause the PCF to no longer trust the UE policy information stored in the network when managing UE policies.

Accordingly, the disclosure provides a method and device for synchronizing a UE policy between a network and a UE in a wireless communication system.

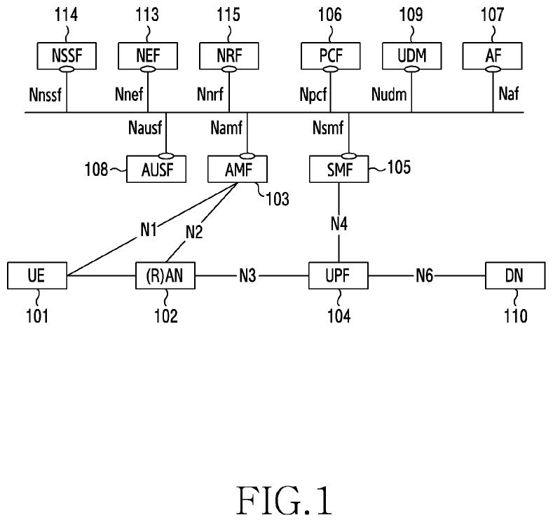

In the disclosure, the network technology may refer to standardized specifications defined by the International Telecommunication Union (ITU) or 3GPP (for example, TS 23.501, TS 23.502, TS 23.503, etc.). Components included in the network architecture illustrated in FIG. 1 below may refer to physical entities, or to software, or hardware combined with software, which performs individual functions. In the drawings, reference numerals denoted as Nx such as N1, N2, N3, etc. represent well-known interfaces between NFs in the 5G core network (CN).

FIG. 1 illustrates a network architecture and interface of a 5G system according to an embodiment of the disclosure.

A network entity included in the network architecture of the 5G system in FIG. 1 may include a network function (NF) depending on the system implementation.

Referring to FIG. 1, the network architecture of the 5G system may include various network entities. For example, the 5G system may include an authentication server function (AUSF) 108, an access and mobility management function (AMF) 103, a session management function (SMF) 105, a policy control function (PCF) 106, an application function (AF) 107, a unified data management (UDM) 109, a data network (DN) 110, a network exposure function (NEF) 113, a network slicing selection function (NSSF) 114, a network repository function (NRF) 115, an edge application service domain repository (EDR) (not shown), an edge application server (EAS) (not shown), an EAS discovery function (EASDF) (not shown), a user plane function (UPF) 104, a (radio) access network ((R)AN) 102, and a terminal, i.e., a user equipment (UE) 101.

Each NF of the network architecture of the 5G system may support the following functions. However, it is not limited thereto.

The AUSF 108 processes and stores data for the authentication of the UE 101.

The AMF 103 provides access and mobility management functions for each UE, and one UE is typically associated with a single AMF. Specifically, the AMF 103 supports signaling between core network (CN) nodes for mobility between 3GPP access networks, termination of the radio access network (RAN) control plane (CP) interface (i.e., the N2 interface), termination of non-access stratum (NAS) signaling (N1), NAS signaling security (NAS ciphering and integrity protection), access stratum (AS) security control, registration management (including registration area management, connection management, idle mode UE reachability (including control and execution of paging retransmission), mobility management control (subscription- and policy-based), support for intra-system and inter-system mobility, support for network slicing, SMF selection, lawful intercept (LI) (including AMF events and interfacing with the LI system), provision of forwarding of session management (SM) messages between the UE and the SMF, transparent proxy functionality for routing SM messages, access authentication, access authorization including roaming permission verification, provision of SMS message delivery between the UE and the SMSF (short message service function), security anchor function (SAF), and/or security context management (SCM). The functions of the AMF 103 may be partially or fully supported within a single instance of the AMF.

The DN 110 refers to, for example, an operator service, internet access, or a third-party service. The DN 110 transmits a downlink protocol data unit (PDU) to the UPF 104, or receives, via the UPF 104, a PDU transmitted from the UE 101.

The PCF 106 receives information about packet flow from an application server and provides a function for determining policies such as mobility management and session management. Specifically, the PCF 106 supports functions such as supporting a unified policy framework for controlling network operations, providing policy rules to enable one or more control plane functions (e.g., AMF 103, SMF 105, etc.) to enforce the policy rules, and implementing a front end for accessing related subscription information for policy determination in a user data repository (UDR).

The SMF 105 provides a session management function, and when the UE 101 has multiple sessions, each session may be managed by a different SMF. Specifically, the SMF 105 supports functions such as session management (e.g., session establishment, modification, and release, including maintenance of tunnels between the UPF 104 and the (R)AN 102 node), UE IP address allocation and management (optionally including authentication), selection and control of user plane (UP) functions, configuration of traffic steering to route traffic to appropriate destinations in the UPF 104, termination of interfaces toward policy control functions, enforcement of policy and quality of service (QoS) control, lawful interception (LI) (for SM events and interfaces to LI systems), termination of the SM part of NAS messages, downlink data notification, initiation of AN specific SM information (delivered to the (R)AN 102 via N2 via the AMF 103), determination of session and service continuity (SSC) modes, roaming functions, etc. Some or all of the functionalities of the SMF 105 may be supported within a single instance of the SMF.

The UDM 109 stores user subscription data, policy data, etc. The UDM 109 includes two components, namely, an application front end (FE) (not shown) and a user data repository (UDR) (not shown).

The front end (FE) (not shown) includes the UDM FE responsible for location management, subscription management, and credential processing, and the PCF responsible for policy control. The UDR stores data required for functions provided by the UDM-FE and policy profiles required by the PCF. Data stored in the UDR includes user subscription data and policy data including subscription identifiers, security credentials, access and mobility-related subscription data, and session-related subscription data. The UDM-FE accesses subscription information stored in the UDR and supports functions such as authentication credential processing, user identification handling, access authentication, registration/mobility management, subscription management, and SMS management.

The UPF 104 transmits a downlink PDU received from the DN 110 to the UE 101 via the (R)AN 102, and transmits an uplink PDU received from the UE 101 to DN 110 via the (R)AN 102. Specifically, the UPF 104 supports functions such as an anchor point for intra/inter RAT mobility, an external PDU session point for interconnection to a data network, packet routing and forwarding, packet inspection and policy rule enforcement of user plane part, lawful intercept, traffic usage reporting, an uplink classifier to support routing of traffic flows to data networks, a branching point to support multi-homed PDU sessions, QoS handling for the user plane (e.g., packet filtering, gating, uplink/downlink rate enforcement), uplink traffic validation (mapping of service data flows (SDFs) to QoS flows), transport level packet marking in uplink and downlink, and downlink packet buffering and triggering of downlink data notifications. The functions of UPF 104 may be partially or fully supported within a single instance of the UPF.

The AF 107 interacts with the 3GPP core network to provide services (e.g., supporting functions such as application influence on traffic routing, access to network capability exposure, and interaction with the policy framework for policy control).

The (R)AN 102 collectively refers to a new radio access network capable of supporting both evolved E-UTRA, which is an advanced version of the 4G radio access technology, and a new radio access technology (NR), such as a gNB.

The gNB supports functions for radio resource management (i.e., radio bearer control, radio admission control, connection mobility control, and dynamic allocation of resources (i.e., scheduling) to the UE in uplink and downlink), internet protocol (IP) header compression, encryption and integrity protection of user data streams, and selection of the AMF 103 during UE attachment when routing to the AMF is not determined from information provided by the UE, user plane data routing to one or more UPFs 104, control plane information routing to the AMF 103, connection setup and release, scheduling and transmission of paging messages (paging messages originated from the AMF 103), scheduling and transmission of system broadcast information (system broadcast information originated from the AMF 103 or from operating and maintenance (O&M)), configuration of measurements and measurement reporting for mobility and scheduling, transport level packet marking in uplink, session management, support for network slicing, QoS flow management and mapping to data radio bearers, support for UEs in inactive mode, distribution of NAS messages, NAS node selection, radio access network sharing, dual connectivity, and tight interworking between NR and E-UTRA.

The UE 101 refers to a user device. The user device may also be referred to as a terminal, mobile equipment (ME), or mobile station (MS). In addition, the user device may be a portable device such as a laptop, mobile phone, personal digital assistant (PDA), smartphone, or multimedia device, or a non-portable device such as a personal computer (PC) or an in-vehicle device.

The NEF 113 provides a means to securely expose services and capabilities, such as those for third parties, internal exposure/re-exposure, application functions, and edge computing, provided by 3GPP network functions. The NEF 113 receives information from other NF(s) (based on the exposed capability(s) of the other NF(s)). The NEF 113 may store the received information as structured data using a standardized interface to a data storage network function. The stored information may be re-exposed by the NEF 113 to other NF(s) and AF(s) and utilized for other purposes, such as analysis.

The NRF 115 supports a service discovery function. The NRF receives NF discovery requests from NF instances and provides information on the discovered NF instance to the requesting NF instance. In addition, the NRF maintains available NF instances and the services supported thereby.

For convenience of explanation, FIG. 1 illustrates a reference model in which the UE 101 accesses a single DN 110 by using a single PDU session. However, the disclosure is not limited thereto.

The UE 101 may access, for example, two data networks (i.e., a local and a central DN) simultaneously by using multiple PDU sessions. In this case, two SMFs may be selected for the respective PDU sessions. However, each SMF may have the capability to control both a local UPF and a central UPF within the PDU session.

In addition, the UE 101 may also access, for example, two (i.e., local and central) data networks simultaneously, provided within a single PDU session.

The NSSF 114 may select a set of network slice instances serving the UE 101. In addition, the NSSF 114 may determine the allowed network slice selection assistance information (NSSAI) and, when required, may perform mapping to the subscribed single network slice selection assistance information (S-NSSAI). In addition, the NSSF 114 may determine the configured NSSAI and, when required, may perform mapping to the subscribed S-NSSAIs. In addition, the NSSF 114 may determine a set of AMFs 103 to be used for serving the UE 101, or, depending on the configuration, may query the NRF 115 to determine a list of candidate AMFs 103.

The NRF 115 supports a service discovery function. The NRF receives NF discovery requests from NF instances and provides the information on the discovered NF instances to the requesting NF instance. In addition, the NRF maintains available NF instances and the services supported thereby.

In 3GPP systems, conceptual links connecting NFs in the 5G system are defined as reference points. In the following, examples of reference points included in the 5G system architecture described in FIG. 1 are provided below.
N1: A reference point between a UE and an AMF
N2: A reference point between an (R)AN and an AMF
N3: A reference point between an (R)AN and a UPF
N4: A reference point between an SMF and a UPF
N5: A reference point between a PCF and an AF
N6: A reference point between a UPF and a data network
N7: A reference point between an SMF and a PCF
N8: A reference point between a UDM and an AMF
N9: A reference point between two core UPFs
N10: A reference point between a UDM and an SMF
N11: A reference point between an AMF and an SMF
N12: A reference point between an AMF and an AUSF
N13: A reference point between a UDM and an AUSF
N14: A reference point between two AMFs
N15: A reference point between a PCF and an AMF for a non-roaming scenario, and a reference point between a PCF and an AMF in a visited network for a roaming scenario

In the following descriptions, a UE may refer to the UE 101, and the terms UE and terminal may be used interchangeably. In this case, unless specifically defined additionally, a UE may be understood as the UE 101.

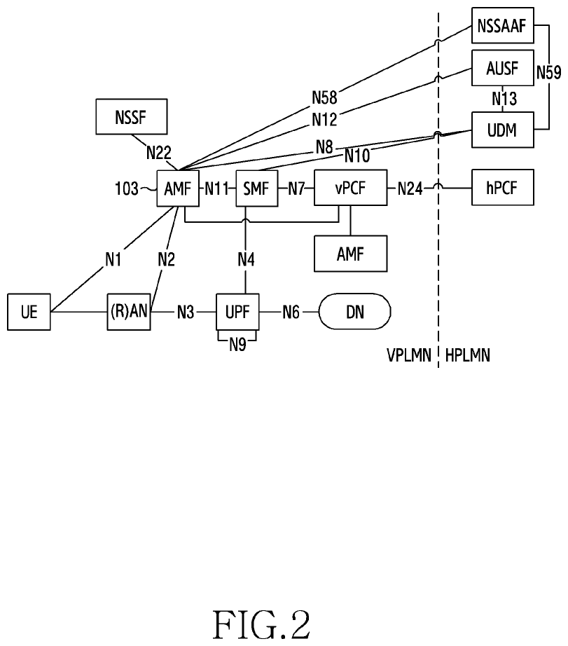

FIG. 2 illustrates the roaming architecture of a wireless communication system according to an embodiment of the disclosure. Since the basic functions of the NFs shown in FIG. 2 are the same as those of the corresponding NFs in FIG. 1, a description of the basic functions of the NFs illustrated in FIG. 2 will be omitted.

FIG. 2 illustrates a local breakout (LBO) scenario in the roaming architecture, in which the UE's data traffic is routed within the visited network (Visited Public Land Mobile Network, VPLMN) without passing through the home network (Home Public Land Mobile Network, HPLMN). The hPCF, which is PCF of the home network, and the vPCF, which is PCF of the visited network, may communicate with each other via reference point N24.

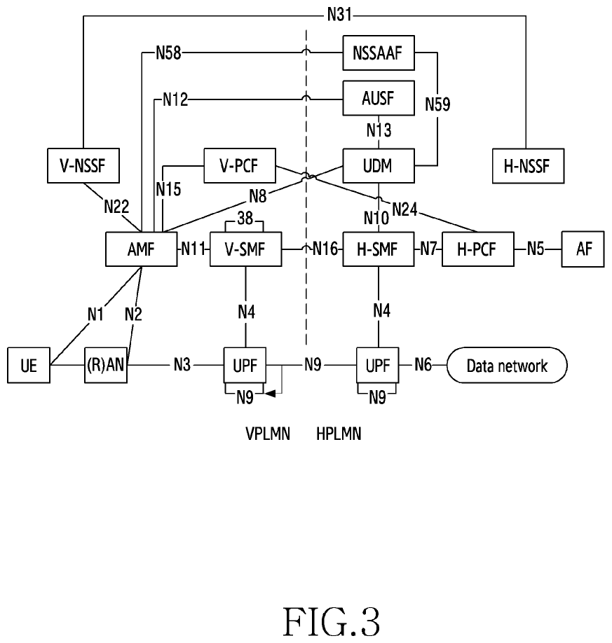

FIG. 3 illustrates a roaming architecture of a wireless communication system according to an embodiment of the disclosure. Since the basic functions of the NFs shown in FIG. 3 are the same as those of the corresponding NFs in FIG. 1, a description of the basic functions of the NFs illustrated in FIG. 3 will be omitted. The roaming architecture in FIG. 3 illustrates a home routing scenario in which the UE's data traffic is routed from the home network (HPLMN) to the visited network (VPLMN). H-PCF, H-SMF, and H-UPF, which are PCF, SMF, and UPF of the home network, and V-PCF, V-SMF, and V-UPF, which are PCF, SMF, and UPF of the visited network may communicate with each other via reference points N24, N16, and N9, respectively.

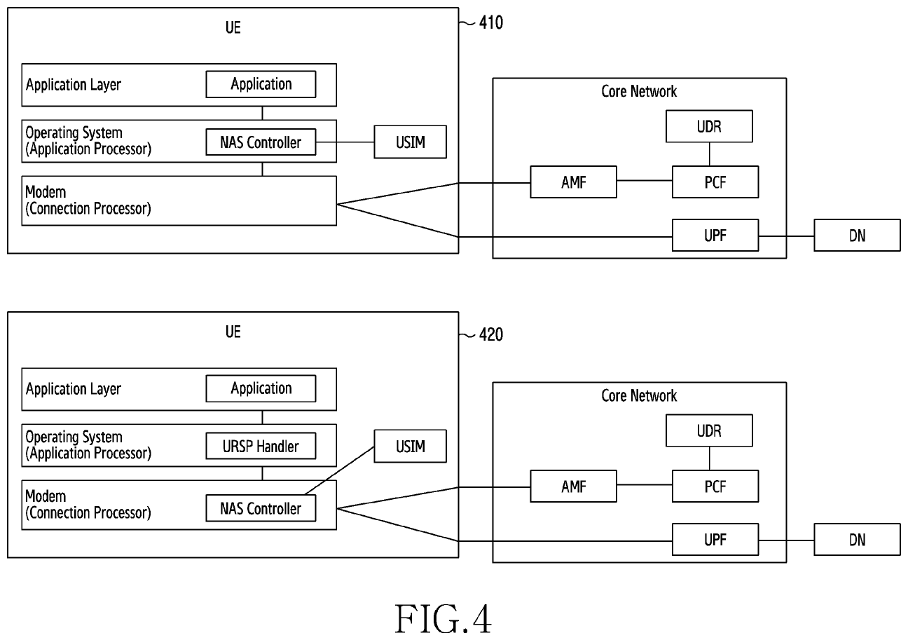

FIG. 4 illustrates a network architecture and interfaces of a 5G system according to an embodiment of the disclosure.

In FIG. 4, UEs may be classified as OS-centric UE 410 or modem-centric UE 420, depending on the location of the NAS controller, which is responsible for handling NAS messages exchanged between the UE and the core network (CN).

Referring to FIG. 4, the OS centric UE 410 may include an application layer, an operating system, a modem, and a universal subscriber identity module (USIM). The modem may operate in a connection processor. The modem may be connected to a control plane and a user plane of a core network. In the case of the control plane, the OS centric UE 410 may be connected to an AMF via the radio access network (RAN) and via the N1 interface. In the case of the user plane, the OS centric UE 410 may be connected to a UPF via the RAN, and the RAN and the UPF may be connected via an N3 interface. The UPF may be connected to a DN via an N6 interface. The operating system may operate in an application processor. The operating system may include a NAS controller. The modem may transmit data corresponding to an NAS message among the data received from the core network to the NAS controller of the operating system, and the operating system may generate a NAS message from control plane data to be transmitted to the core network and deliver the NAS message to the modem. The NAS controller may store the UE policy information provided by the PCF to the UE or transmit requests related to policy information stored in the UE to the core network. In addition, the NAS controller may receive a subscriber profile (subscriber data, configuration information, policy information) from the USIM, and when the user changes the USIM (e.g., by physically replacing or removing a USIM card, or downloading/deleting eSIM data), the NAS controller may recognize the change and identify the new USIM. One or more applications may run in the Application Layer. When an application is executed, data generated by the application may be delivered to the NAS controller. Based on the UE policy (including URSP rules and ANDSP rules) received from the PCF, the NAS controller may determine whether to establish a new PDU session or use an existing PDU session.

According to an embodiment of the disclosure, the NAS controller may be located in the modem instead of the operating system, depending on the implementation of the UE. In this case, among the various types of NAS messages received from the core network, the function of identifying and processing the relationship between specific UE policy information and application data may be separated, and the function may be performed by the operating system. In the drawing, an example is illustrated in which a URSP Handler, located in the operating system, is responsible for determining how to associate the URSP rules provided by the PCF with application data running on the modem-centric UE 420, and for determining whether to establish a new PDU session or to use an existing one when a specific application is executed. In this case, the entity that recognizes and identifies the modification/deletion of the USIM may correspond to the NAS controller, and the USIM may communicate with the NAS controller located in the modem.

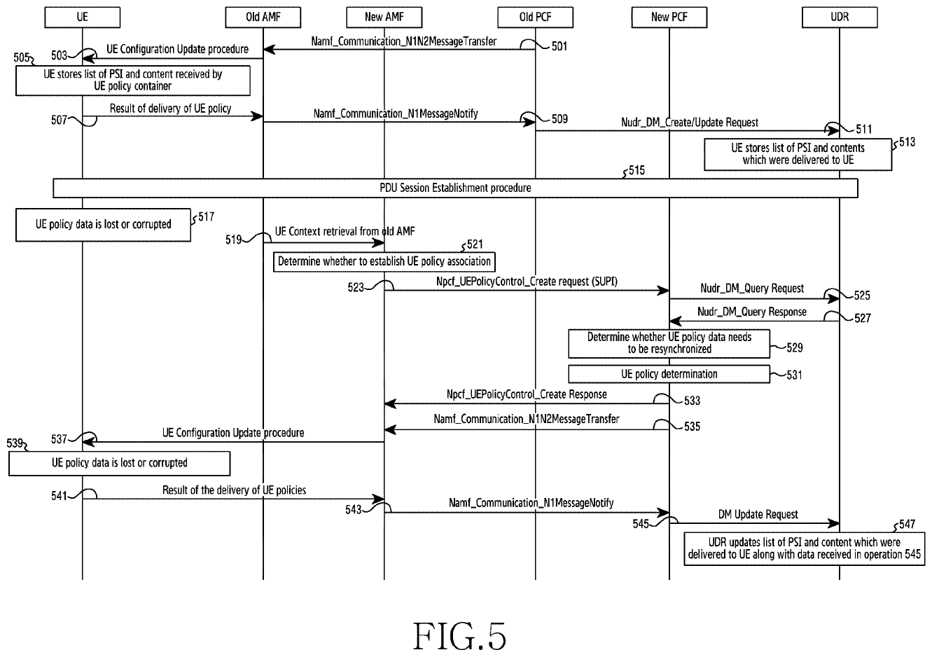

FIG. 5 illustrates a UE policy synchronization procedure between a network and a UE according to an embodiment of the disclosure. More specifically, FIG. 5 illustrates a procedure in which, when a network determines that there is a possibility of mismatch between UE policy information stored in the network and UE policy information stored in a UE, the network requests the UE to maintain the UE policy information stored in the UE in accordance with the information determined by the network.

Referring to FIG. 5, an AMF relocation procedure including PCF change is illustrated as an example of a process in a non-roaming system in which the network determines that “there is a possibility of mismatch between the UE policy information stored in the network and the UE policy information stored in the UE.”

In operation 501, the old PCF may deliver the UE policy to the old AMF. The UE policy data may be divided into one or more policy sections, each having a predetermined size, and provided accordingly. Each policy section may be identified by a policy section identifier (PSI). For example, the old PCF may determine to provide the UE with UE policy data including three policy sections. In this case, the old PCF may generate a list consisting of PSI #1, the UE policy data constituting PSI #1, PSI #2, the UE policy data constituting PSI #2, PSI #3, and the UE policy data constituting PSI #3. This PSI list and each UE policy data may be encapsulated in a UE policy container and delivered to the old AMF. The old AMF cannot read the information inside the UE policy container. The old PCF may provide the UE policy container to the old AMF by using the Namf_Communication_N1N2MessageTransfer message.

In operation 503, the old AMF may perform a UE configuration update procedure to deliver the UE policy to the UE. The old AMF may provide the UE with the UE policy container received from the old PCF in operation 501, by using a NAS message.

In operation 505, the UE may read the information inside the UE policy container received from the old AMF to identify and store the UE policy data. According to the example described in operation 501, the UE may identify PSI #1, PSI #2, and PSI #3, along with the UE policy data constituting each PSI, and may store PSI #1, PSI #2, and PSI #3, along with the UE policy data constituting each PSI.

In operation 507, the UE may respond to the old AMF with the result of the UE policy transmission (e.g., success or failure).

In operation 509, the old AMF may deliver the result of the UE policy transmission to the old PCF. At this time, the old AMF may deliver the result of the UE policy transmission to the old PCF by using the Namf_Communication_N1MessageNotify message.

In operation 511, when the old PCF receives and identifies from the old AMF that the UE policy has been successfully transmitted to the UE, the old PCF may store, in the UDR, the UE policy information transmitted to the UE. The old PCF may use a Nudr_DM_Create Request or Nudr_DM_Update Request message to request the UDR to store the UE policy information. When the old PCF sends the Nudr_DM_Create Request or Nudr_DM_Update Request message to the UDR, the old PCF may provide “policy data” as the value of the data set, “policy set entry data” as the value of the data subset, and the SUPI as a UE identifier. However, the data set and data subset values may use values other than “policy data” and “policy set entry data”, and are not limited thereto.

In operation 513, the UDR may store the UE policy information received in operation 511, which is delivered to the UE, as the most recent UE policy information transmitted to the UE. For example, the UDR may store PSI #1, PSI #2, and PSI #3, along with the UE policy data constituting each PSI, as the most recent UE policy information.

In operation 515, the UE and network entities may establish one or more PDU sessions to provide communication services.

In operation 517, the UE may lose the UE policy information stored in operation 505, or the policy information may be damaged. For example, referring to the description in FIG. 4, there may be a case in which when the USIM has been changed, or when a user command causes a reset that is configured to erase the UE policy data (e.g., when the user performs a factory reset). In this case, the UE may no longer retain the UE policy information, or the previously stored UE policy data may be considered unreliable. The UE may then determine that it is in a state in which no UE policy information is stored. Operation 517 may occur at any time after operation 505 and before operation 537.

In operation 519, the old AMF may deliver information about the UE policy association established with the old PCF for the UE to the new AMF, based on the mobility information of the UE and/or the network configurations. The UE policy association information may include at least one of policy control request trigger information and the PCF ID of the old PCF. FIG. 5 illustrates based on a non-roaming situation, and in the roaming situation, the PCF ID may include the old H-PCF ID and the old V-PCF ID.

In operation 521, the new AMF may determine whether to establish a new UE policy association, based on the information about the UE policy association received from the old AMF in operation 519. The new AMF may select the new PCF other than the old PCF provided in operation 519, according to the mobility information of the UE and/or the network configuration, and in this case, the new AMF may determine that a new UE policy association needs to be established rather than updating the existing one.

In operation 523, the new AMF that has determined a new establishment in operation 521 may request the new PCF to establish a UE policy association and may provide an identifier of the UE. The new AMF may use the Npcf_UEPolicyControl_Create request message to request the establishment of the UE policy association and may provide SUPI as a UE identifier.

In operation 525, upon a request from the new AMF to establish a UE policy association, the new PCF may request the UDR for the most recent UE policy information transmitted to the UE. The new PCF may request the UDR for the most recent UE policy information transmitted to the UE by using the Nudr_DM_Query Request message. When the new PCF transmits the Nudr_DM_Query Request message, the new PCF may provide “policy data” as the value of the data set, “policy set entry data” as the value of the data subset, and the SUPI received in operation 523 as a UE identifier.

In operation 527, the UDR may provide the new PCF with the latest UE policy information transmitted to the UE having been stored therein. At this time, when no change related to the UE policy information has been provided to the UDR since operation 513, the UE policy information having been stored in the UDR may be the same as the information stored in operation 513. The UDR may provide the UE policy information to the new PCF by using the Nudr_DM_Query Response message, and the message may include the latest UE policy information transmitted to the UE (the latest list of PSIs delivered to the UE). For example, the UDR may provide PSI #1, PSI #2, and PSI #3, along with the UE policy data constituting each PSI, which are stored in operation 513.

In operation 529, the new PCF may determine whether re-synchronization of the UE policy data between the network and the UE is necessary. When the new PCF may determine that there is a possibility of mismatch between the UE policy information stored in the network and the UE policy information stored in the UE, the new PCF may determine that re-synchronization of UE policy data between the network and the UE is required. For example, the new PCF may determine whether re-synchronization of UE policy data between the network and the UE is required in the following cases. However, it is not limited thereto.

In the first case, the new PCF receives a request to establish a UE policy association from the new AMF in operation 523, but the request does not include a UE policy container, while in operation 527, the new PCF receives UE policy information from the UDR that is previously transmitted to the UE. Based on that the new PCF has received UE information previously delivered to the UE from the UDR, the new PCF may recognize that the request to establish a UE Policy association in operation 523 is not a completely new request, but rather a request related to a previously established UE policy association. The new PCF may determine that there is a possibility of mismatch between the information received from the UDR in operation 527 and the information actually stored in the UE.

In the second case, when the new PCF receives a request to establish a UE policy association from the new AMF in operation 523, but the request does not include a UE policy container, the new PCF may refer to information that allows the new PCF to infer that “there is a possibility of mismatch between the UE policy information stored in the network and the UE policy information stored in the terminal.” For example, this may include a case in which the new PCF is notified by the UDR that changes have occurred in subscriber information related to the UE policy data (in this case, the UDR may use the Nudr_DM_Notify message), or a case in which the UDR notifies the PCF of URSP guidance information requested by an AF (in other words, the AF requested a change in URSP information, and the UDR delivers the request to the PCF) (in this case, the UDR may use the Nudr_DM_Notify message).

In operation 531, the new PCF may determine the UE policy. For example, the new PCF may determine UE policy information that differs from the UE policy information received from the UDR in operation 527. The UE policy information may be assumed to be divided into two policy sections.

In operation 533, the new PCF may determine the policy control request trigger information for the UE policy determined in operation 531 and may provide the determined policy control request trigger information to the new AMF. The new PCF may use the Npcf_UEPolicyControl_Create Response message to provide the information to the new AMF, and the Npcf_UEPolicyControl_Create Response message may include the trigger information.

In operation 535, the new PCF may deliver the UE policy information determined in operation 531 to the new AMF in order to provide the UE policy information to the UE. When the new PCF determines in step 529 that re-synchronization of the UE policy data between the network and the UE is necessary, the new PCF may provide an indicator requesting re-synchronization (hereinafter, UE policy (UEPO) re-synchronization indication). For example, the new PCF may provide a UE policy container by using a Namf_Communication_N1N2MessageTransfer message, and the UE policy container may include a UEPO re-synchronization indication, as well as a list containing the UE policy information determined in operation 531 and divided into two policy sections including PSI #1, the UE policy information constituting PSI #1, PSI #2, and the UE policy information constituting PSI #2.

In addition, when any policy section included in the policy information received from the UDR in operation 527 becomes unnecessary when the UE policy determined in operation 531 is applied, the new PCF may inform the AMF of the existence and request removal of the corresponding policy section by providing the only the PSI of the corresponding policy section to the UE without the policy information. For example, when the new PCF received a list of three PSIs and the UE policy information thereof in operation 527, but determines a new UE policy information including two PSIs in operation 531, the new PCF may divide the new UE policy information determined in operation 531 into PSI #1 and PSI #2, and request that PSI #3 be removed from the UE's storage. In this case, the UE policy container may include the UEPO re-synchronization indication, and a list containing the UE policy information determined in operation 531 and divided into two policy sections, and PSI #3 without UE policy information, the two policy sections including PSI #1, the UE policy information constituting PSI #1, PSI #2, and the UE policy information constituting PSI #2.

In operation 537, the new AMF may deliver the UE policy container received in operation 535 to the UE.

In operation 539, the UE may read the information within the UE policy container received from the new AMF and identify and store the UE policy data. In this case, when the UE receives a UEPO re-synchronization indication, the UE may determine how to replace or delete UE policy information that is stored or not stored in the UE, and how to store the UE policy data received from the new AMF, as follows.

In the case in which a PSI with the same value has previously been provided to the UE and should continue to be applied (e.g., PSI #1 and PSI #2 in the example described above):
When the corresponding PSI is lost in the UE (e.g., due to reasons such as in operation 517), the UE may store the UE policy information delivered via operation 537 as is.
When the corresponding PSI is still stored in the UE, the UE may replace the existing UE policy information with the UE policy information delivered via operation 537 and store the same.

In the case in which a PSI with the same value has previously been provided to the UE but is no longer needed (in other words, the PSI is provided without any UE policy information) (e.g., PSI #3 in the example described above):

When the corresponding PSI has been lost in the UE (e.g., due to reasons such as in operation 517), the UE may ignore the PSI delivered via operation 537 and perform no operation.

When the corresponding PSI is still stored in the UE, the UE may delete the PSI along with the UE policy information constituting the PSI.

In operation 541, the UE may respond to the new AMF with the result of the UE policy delivery (e.g., success or failure).

In operation 543, the new AMF may deliver the result of the UE policy delivery to the new PCF. The new AMF may use the Namf_Communication_N1MessageNotify message.

In operation 545, when the new PCF identifies that the UE policy has been successfully transmitted to the UE, the new PCF may store, in the UDR, the UE policy information that is determined in operation 531 and transmitted to the UE via operations 535 to 537. When requesting the UDR to store the UE policy information, the new PCF may use the Nudr_DM_Update Request message, and provide “policy data” as the value of the data set, “policy set entry data” as the value of the data subset, the most recent UE policy information transmitted to the UE (e.g., a list including PSI #1, the UE policy information constituting PSI #1, PSI #2, the UE policy information constituting PSI #2, and PSI #3 without UE policy information), and SUPI as a UE identifier.

In operation 547, the UDR may store the most recent UE policy information transmitted to the corresponding UE, in accordance with the request from the new PCF in operation 545. For example, PSI #1 and PSI #2 stored in operation 513 may be replaced with the UE policy information received in operation 545, and PSI #3 and the UE policy information constituting PSI #3 may be deleted.

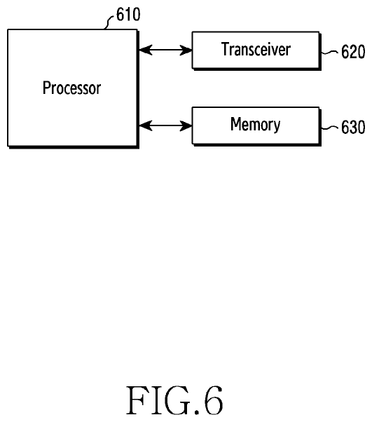

FIG. 6 illustrates a structure of a base station according to an embodiment of the disclosure.

Referring to FIG. 6, the base station may include a processor 610, a transceiver 620, and a memory 630. The processor 610, the transceiver 620, and the memory 630 may operate according to the above-described communication methods of the base station. A network device may also correspond to the structure of the base station. However, components of the base station are not limited to the above-described example. For example, the base station may include a larger or smaller number of components than the above-described components. For example, the base station may include the transceiver 620 and the processor 610. Furthermore, the transceiver 620, the processor 610, and the memory 630 may be implemented in the form of a single chip.

The transceiver 620 refers to a base station receiver and a base station transmitter as a whole, and may transmit/receive signals with UEs, other base stations, and other network devices. The transmitted/received signals may include control information and data. The transceiver 620 may transmit, for example, system information, synchronization signals, or reference signals to the UE. To this end, the transceiver 620 may include an RF transmitter configured to up-convert and amplify the frequency of transmitted signals, an RF receiver configured to low-noise-amplify received signals and down-convert the frequency thereof, and the like. However, this is only an embodiment of the transceiver 620, and the components of the transceiver 620 are not limited to the RF transmitter and the RF receiver. The transceiver 620 may include wired/wireless transceivers, and may include various components for transmitting/receiving signals. In addition, the transceiver 620 may receive signals through a communication channel (e.g., a radio channel), output the same to the processor 610, and transmit signals output from the processor 610 through the communication channel. Furthermore, the transceiver 620 may receive communication signals, output same to a processor, and transmit signals output from the processor to the UE, other base stations, or other network entities through a wired/wireless network.

The memory 630 may store programs and data necessary for operations of the base station. In addition, the memory 630 may store control information or data included in a signal acquired by the base station. The memory 630 may include storage media such as a ROM, a RAM, a hard disk, a CD-ROM, and a DVD, or a combination of storage media. In addition, the memory 630 may store at least one of information transmitted/received through the transceiver 620 and information generated through the processor 610.

As used herein, the processor 610 may be defined as a circuit or an application-specific integrated circuit. The processor may include a communication processor (CP) which performs control for communication and an application processor (AP) which controls upper layers such as application programs. The processor 610 may control the overall operation of the base station according to the embodiments proposed in the disclosure. For example, the processor 610 may control signal flows between the respective blocks to perform operations according to the above-described flowcharts.

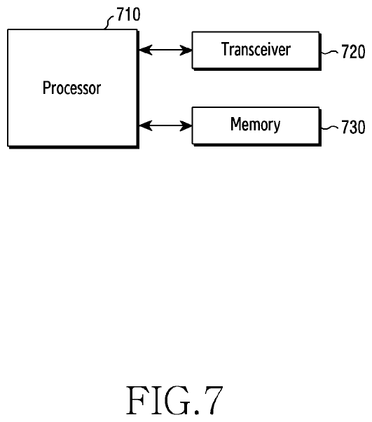

FIG. 7 illustrates a structure of a UE according to an embodiment of the disclosure.

Referring to FIG. 7, the UE may include a processor 1030, a transceiver 1010, and a memory 1020. The processor 710, the transceiver 720, and the memory 730 may operate according to the above-described communication methods of the UE. Components of the UE are not limited to the above-described example. For example, the UE may include a larger or smaller number of components than the above-described components. For example, the UE may include the transceiver 720 and the processor 710. Furthermore, the transceiver 720, the processor 710, and the memory 730 may be implemented in the form of a single chip.

The transceiver 720 refers to a UE receiver and a UE transmitter as a whole, and may transmit/receive signals with base stations and other UEs or network entities. The signals transmitted/received with the base stations may include control information and data. The transceiver 720 may receive, for example, system information, synchronization signals, or reference signals from the base stations. To this end, the transceiver 720 may include an RF transmitter configured to up-convert and amplify the frequency of transmitted signals, an RF receiver configured to low-noise-amplify received signals and down-convert the frequency thereof, and the like. However, this is only an embodiment of the transceiver 720, and the components of the transceiver 720 are not limited to the RF transmitter and the RF receiver. Also, the transceiver 720 may include wired/wireless transceivers, and may include various components for transmitting/receiving signals. In addition, the transceiver 720 may receive signals through a radio channel, output the same to the processor 710, and transmit signals output from the processor 710 through the radio channel. Furthermore, the transceiver 720 may receive communication signals, output same to a processor, and transmit signals output from the processor to a network entity through a wired/wireless network.

The memory 730 may store programs and data necessary for operations of the UE. In addition, the memory 730 may store control information or data included in signals acquired by the UE. The memory 730 may include storage media such as a ROM, a RAM, a hard disk, a CD-ROM, and a DVD, or a combination of storage media.

As used herein, the processor 710 may be defined as a circuit or an application-specific integrated circuit. The processor may include a communication processor (CP) which performs control for communication and an application processor (AP) which controls upper layers such as application programs. The processor 710 may control the overall operation of the UE according to the embodiments proposed in the disclosure. For example, the processor 720 may control signal flows between the respective blocks to perform operations according to the above-described flowcharts.

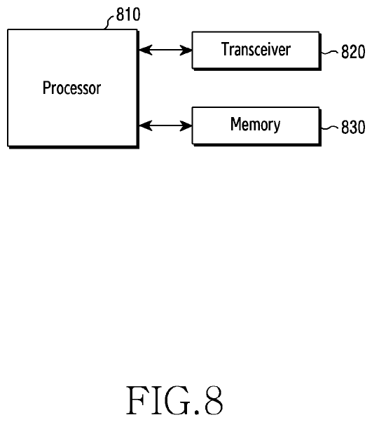

FIG. 8 illustrates a structure of a network entity in a wireless communication system according to an embodiment of the disclosure.

The network entity in FIG. 8 may be at least one of the network functions (NFs), such as the UE, the RAN (base station), the AMF, the PCF, and the UDR, described in the embodiments of FIGS. 1 to 5.

The network entity according to an embodiment of the disclosure may include a processor 810 which controls the overall operation of the network entity, a transceiver 820 which includes a transmitter and a receiver, and a memory 830. Of course, the example given above is not limiting, and the network entity may include a smaller or larger number of components than the components illustrated in FIG. 8.

According to an embodiment of the disclosure, the transceiver 820 may transmit/receive signals with at least one of other network entities or UEs. The transmitted/received signals may include at least one of control information and data. In the case where the network entity in FIG. 8 is an entity of a core network, the signals transmitted/received between the network entity and a UE may be transmitted/received via an RAN.

According to an embodiment of the disclosure, the processor 810 may control the overall operation of the network entity to perform the operations according to one of the above-described embodiments of FIGS. 1 to 5 or any combination of two or more thereof. The processor 810, the transceiver 820, and the memory 830 are not necessarily implemented as separate modules, but may be implemented as a single component unit such as a single chip. In addition, the processor 810 may be an application processor (AP), a communication processor (CP), a circuit, an application-specific circuit, or at least one processor. The transceiver 820 may include an interface which wiredly/wirelessly transmits/receive signals to/from UEs, other base stations, or network entities.

According to an embodiment of the disclosure, the memory 830 may store data such as basic programs for operations of the network entity, application programs, and configuration information. In addition, the memory 830 provides the stored data at the request of the processor 810. The memory 830 may include storage media such as a ROM, a RAM, a hard disk, a CD-ROM, and a DVD, or a combination of storage media. In addition, the memory 830 may include multiple memories. Furthermore, the processor 810 may perform at least one of the above-described embodiments of the disclosure, based on the programs for performing at least one of the embodiments, stored in the memory 830.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a policy control function (PCF) entity in a wireless communication system, the method comprising:
receiving, from an access and mobility management function (AMF) entity, a first message comprising information requesting establishment of a user equipment (UE) policy association with a UE;
receiving, from a user data repository (UDR) entity, a second message comprising information related to a first UE policy;
based on the first message and the second message, identifying whether re-synchronization of UE policy information is required;
in case that a UE policy container is not included in the information requesting establishment of the UE policy association, identifying re-synchronization of the UE policy information; and
based on identification of the re-synchronization, identifying a second UE policy different from the first UE policy.

2. The method of claim 1, comprising transmitting information related to the second UE policy to the UE via the AMF entity,
wherein the information related to the second UE policy comprises an indicator indicating re-synchronization of the information related to the first UE policy.

3. The method of claim 2, wherein the indicator is used by the UE to identify whether to modify or delete the information related to the first UE policy.

4. The method of claim 1, wherein the first UE policy indicates a UE policy transmitted to the UE by the UDR entity before the identification of the re-synchronization.

5. A policy control function (PCF) entity in a wireless communication system, the PCF entity comprising:
a transceiver; and
a controller coupled to the transceiver,
wherein the controller is configured to:
receive, from an access and mobility management function (AMF) entity, a first message comprising information requesting establishment of a user equipment (UE) policy association with a UE;
receive, from a user data repository (UDR) entity, a second message comprising information related to a first UE policy;
based on the first message and the second message, identify whether re-synchronization of UE policy information is required;
in case that a UE policy container is not included in the information requesting establishment of the UE policy association; and
based on identification of the re-synchronize, identify a second UE policy different from the first UE policy.

6. The PCF entity of claim 5, wherein the controller is further configured to transmit information related to the second UE policy to the UE via the AMF entity, and
wherein the information related to the second UE policy comprises an indicator indicating re-synchronization of the information related to the first UE policy.

7. The PCF entity of claim 6, wherein the indicator is used by the UE to identify whether to modify or delete the information related to the first UE policy.

8. The PCF entity of claim 7, wherein the first UE policy indicates a UE policy transmitted to the UE by the UDR entity before the identification of the re-synchronization.

9. A method performed by a user equipment (UE) in a wireless communication system, the method comprising:
receiving, from a policy control function (PCF) entity via an access and mobility management (AMF) entity, information related to a second UE policy identified by the PCF entity;
based on an indicator indicating re-synchronization, included in the information related to the second UE policy, identifying whether to modify or delete information related to a first UE policy; and
transmitting a result of re-synchronization of UE policy information to the PCF entity via the AMF entity.

10. The method of claim 9, wherein the second UE policy indicates a UE policy different from the first UE policy identified by the PCF entity and stored in the UE, and
wherein the indicator indicates re-synchronization of information related to the first UE policy stored in the UE.

11. The method of claim 9, wherein the identifying of whether to modify or delete the information related to the first UE policy comprises:
in case that the information related to the second UE policy includes a first policy section identifier (PSI) and first policy data constituting the first PSI and related to the second UE policy,
modifying the second policy data to the first policy data in case that the first PSI and second policy data constituting the first PSI and related to the first UE policy are stored in the UE; or
storing the first PSI and the first policy data in case that the first PSI is not stored in the UE.

12. The method of claim 9, wherein the identifying of whether to modify or delete the information related to the first UE policy comprises:
in case that the information related to the second UE policy includes a second PSI and does not include second policy data constituting the second PSI and related to the second UE policy,
deleting the second PSI and third policy data constituting the second PSI and related to the first UE policy in case that the second PSI is stored in the UE; or
ignoring the second PSI in case that the second PSI is not stored in the UE.

13. A user equipment (UE) in a wireless communication system, the UE comprising:
a transceiver; and
a controller coupled to the transceiver,
wherein the controller is configured to:
receive, from a policy control function (PCF) entity via an access and mobility management (AMF) entity, information related to a second UE policy identified by the PCF entity;
based on an indicator indicating re-synchronization, included in the information related to the second UE policy, identify whether to modify or delete information related to a first UE policy; and
transmit a result of re-synchronization of UE policy information to the PCF entity via the AMF entity.

14. The terminal of claim 13, wherein the controller is configured to, in case that the information related to the second UE policy includes a first policy section identifier (PSI) and first policy data constituting the first PSI and related to the second UE policy:
modify the second policy data to the first policy data in case that the first PSI and second policy data constituting the first PSI and related to the first UE policy are stored in the UE; or
store the first PSI and the first policy data in case that the first PSI is not stored in the UE.

15. The terminal of claim 13, wherein the controller is configured to, in case that the information related to the second UE policy includes a second PSI and does not include second policy data constituting the second PSI and related to the second UE policy:
delete the second PSI and third policy data constituting the second PSI and related to the first UE policy in case that the second PSI is stored in the UE; or
ignore the second PSI in case that the second PSI is not stored in the UE.
